(19) United States
(12) Patent Application Publication
(10) Pub. No.: US 2010/0239795 A1
(43) Pub. Date: Sep. 23, 2010

(54) Modular Construction Units and Uses Thereof

(75) Inventor: Dror Gat, Tel Aviv (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SHADE ON IT LTD., Tel Aviv (IL)

(21) Appl. No.: 12/524,854

(22) PCT Filed: Jan. 20, 2008
(86) PCT No.: PCT/IL08/00081

§ 371 Date: Jun. 9, 2010

(30) Foreign Application Priority Data
Jan. 28, 2007 (IL) 180,998

(51) Int. Cl. B32B 3/20; B32B 3/06; B29C 39/12; B29C 47/06; B32B 1/02

(52) U.S. Cl. 428/34.1; 428/188; 428/99; 264/299; 264/173.16; 264/160

(57) ABSTRACT

The invention relates to a modular unit used for constructing various items, the unit being made of a deformable material and characterized in that the unit has a flat element which is co-formed with a plurality of parallel tubular elements attached to a surface thereof, wherein the tubular elements are spaced apart from each other and each tubular element has a common wall with the flat element.

### FIELD OF THE INVENTION

The present invention relates to modular construction units. More particularly, this invention relates to flexible modular construction units for constructing household and other items.

### BACKGROUND OF THE INVENTION

Numerous household items and toys are known in the art comprising rigid elements of different shapes, and, in some cases, non-rigid elements.

Some prior art teaches complex interlocking mechanisms between small rigid pieces. These toys and construction kits generally allow for perpendicular and/or adjacent interconnectivity between the structures. For example, U.S. Pat. No. 2,132,647, to Robins describes a toy construction kit comprising a set of slabs, a set of connectors of dumb bell shape, and sets of pins. U.S. Pat. No. 2,225,612, to Allen, discloses a structural piece of wood having parallel top and bottom faces, said piece having in each of said faces a pair of keyhole slots. Additionally, U.S. Pat. No. 2,735,146, to Purviance, discloses a building block construction comprising building blocks having straight walled substantially V shaped key ways.

U.S. Pat. No. 3,985,461, to Gebhard, discloses tie bars which fasten abutting members, such as of a window, such as extrusions and also function to draw the members into very tight engagement at the butt joint, the joint structure or tie bars comprise a pair of linearly extending metal members disposed in an abutting relationship.

U.S. Pat. No. 5,350,331, to Glickman, discloses a construction toy which includes as principle components a connector having one or more gripping end portions and rod-like structural elements having end portions spacially configured to be received in the gripping sockets.

U.S. Pat. No. 5,957,744, to Mott, discloses a single style elongate tubular extrusion for clamping type edge joining and post type end joining.

U.S. Pat. No. 6,672,026, to Sumerak, discloses a structural system comprising a plurality of I-shaped bearing members and a plurality of connection members each having a plurality of notches.

Other prior art teaches non-perpendicular interconnectivity between the structures, such as, U.S. Pat. No. 2,933,920, to Steuler, discloses a building block containing an intermediate cavity. The building blocks may be assembled to form a curved wall. U.S. Pat. No. 3,160,249, to Pavecka, discloses a linear interlocking key or spline forming rigid connections at fixed angles between various rigid elements.

U.S. Pat. No. 3,348,459, to Harvey, discloses interlocking flexible extruded matting and a coupling bar therefore, and U.S. Pat. No. 3,929,230, to Luthi, discloses a set of units for the construction of various types of stands, comprising holding units shaped to take articles such as candles and plants, and comprising plug-in units.

Some further prior art relates to flexible construction units comprising various modular flexible units having two opposing flat surfaces. For example U.S. Pat. No. 3,975,882, to Walter, discloses an elongate rigid panel structure of selected longitudinal curvature comprising a pair of elongate flexible sub assemblies, each sub-assembly including a flat skin with inner and outer surfaces and a corrugated backing fixed to the inner surface of the skin.

U.S. Pat. No. 4,573,296, to Wrigley, discloses a construction panel comprising a deformable sheet having a plurality of identical uniformly spaced apart parallel forms, each form including a nearly complete circular cylinder, the axis of which is parallel to said common plane and is spaced from said common plane at a predetermined distance, said nearly circular cylinder having adjacent edges.

U.S. Pat. No. 5,016,417, to Mentken, discloses a plurality of sets of locking elements attached to a flat sheet, each set of locking elements comprising a base member, a neck member and a head member. Each complete cylinder is connected via a pair of parallel flat fins to the flat sheet.

There is still a need to develop inexpensive and versatile flexible modular construction units for both permanent and temporary use.

### SUMMARY OF THE INVENTION

One object of the present invention is to provide inexpensive and versatile flexible modular units for both permanent and temporary use.

Another of the objects of the present invention is to provide structural units which can be advantageously set up in a flat form, a bent form, a cylindrical form or a combination thereof, to provide versatile structural units for a large number of domestic and industrial applications. The structural units of the present invention can be bent to establish rounded and finished corners without the necessity for costly and complicated construction processes.

A further object of the present invention is to provide modular units which can be assembled into a plurality of shapes and configurations easily and without the need for skill, and which may be non-destructively disassembled and reassembled into other constructions.

Yet another object of the present invention is to provide a method for preparing a modular unit comprising forming from an extrudable deformable material, such as a plastic, a multi-purpose modular unit, in a process step selected from extrusion and molding. This process step eliminates the need for multi-step production processes including framing, fastening, bonding, insulating, and finishing processes.

An additional object of the present invention is to provide a construction method and material that can be flat-packed, shipped and stored flat, and assembled thereafter on-site, making the products of the present invention useful for “do-it-yourself” products.

There is thus provided in accordance with some embodiments of the present invention, a multi-purpose, modular unit, used for constructing various items, wherein the unit is made of a deformable material and characterized in that the unit has a flat element which is co-extruded with a plurality of parallel tubular elements attached to a surface thereof, and wherein the tubular elements are spaced apart from each other and each tubular element has a common wall with the flat element.

According to some embodiments of the present invention, the modular unit further comprising a pair of slotted end elements, one at each longitudinal end of the sheet, each slotted end element extending the width of the sheet, and parallel to the plurality of parallel tubular elements.

According to some further embodiments of the present invention, each slotted end element comprises a slot extending along an axis in the same plane as the axes of the hollow elements, the slot configured to receive at least one of a connector unit, a rigidifying element and a rigidifying end element connector unit.

In some preferred embodiments, the plurality of tubular elements are uniformly spaced apart. In some cases, the plurality of tubular elements are substantially identical.

According to some embodiments of the present invention, the tubular elements are adapted to receive an internal support member.

In some cases the internal support member is solid, in others it is hollow. The support member may have a circular cross-section or a quadrilateral cross-section, which may be correspondingly closed or open.

According to some embodiments of the present invention, the modular unit is made of an extrudable deformable material selected from: polymers including polystyrene, polyethylene, polybutadiene, polypropylene and polyvinyl chloride and polyurethanes; natural or synthetic rubbers and plastic composites.

In some preferred embodiments, the modular unit may be used in combination with a rigidifying element, said element being provided with at least a pair of spaced-apart projections sized to be inserted into open ends of at least two spaced-apart tubular elements of the same modular unit to fix the spacial relationship therebetween.

According to some further embodiments, the modular unit may be used in combination with a rigidifying end element connector unit, said unit being provided with at least a pair of spaced-apart projections sized to be inserted into open ends of at least two spaced-apart tubular elements of the same modular unit to fix the spacial relationship therebetween.

In some yet further preferred embodiments, the modular unit may be used in combination with at least one connector unit, said connector unit being sized to be inserted into two slots sections selected from two slots sections of the same modular unit to fix the spacial relationship therebetween and one slot on each of two modular units to connect the two modular units together.

According to some embodiments of the present invention, there are provided products comprising at least one modular unit as described herein, wherein the product is selected from a box; a storage container, a closet, a drawer, a piece of furniture, an armchair, a chair, a table, a commode, a shelf, a hammock, a swing, playground equipment, a mat, a shoe, a clog, a bag, a suitcase, a travel case, a buggy, a pram, a storage unit, a shock absorbing item, a sound absorbing item, a car part, a car seat, blood-circulatory equipment, a shed, a storehouse, a wheeled item, a trolley, a moveable item, a wall unit, a roof unit, a tile, bathroom equipment, bathroom furniture, a conveyor belt, an industrial item, a convention exhibit, a theatrical display, a window display, an office partition, a home partition, a piece of knock-down furniture and an animal shelter.

Some other embodiments of the present invention are directed to a construction system comprising:

at least one modular unit as defined above,

at least one of: a connector unit, a rigidifying element and a rigidifying end element connector unit; and

at least one internal support member.

According to some embodiments of the present invention, the products comprising the construction system are selected from a box; a storage container, a closet, a drawer, a piece of furniture, an armchair, a chair, a table, a commode, a shelf, a hammock, a swing, playground equipment, a mat, a shoe, a clog, a bag, a suitcase, a travel case, a buggy, a pram, a storage unit, a shock absorbing item, a sound absorbing item, a car part, a car seat, blood-circulatory equipment, a shed, a storehouse, a wheeled item, a trolley, a moveable item, a wall unit, bathroom equipment, bathroom furniture, a conveyor belt, an industrial item, a convention exhibit, a theatrical display, a window display, an office partition, a home partition, a piece of knock-down furniture and an animal shelter.

According to some embodiments of the present invention, there is provided a method for forming a modular unit as described herein, comprising forming an extrudable deformable material into a flat element and into a plurality of parallel tubular elements attached to a surface thereof, wherein said tubular elements are spaced apart from each other and each tubular element has a common wall with said flat element.

In some cases, the forming step is a process selected from extruding and molding.

In preferred embodiments of the present invention, there is provided a furniture element comprising a modular unit as defined herein.

In some preferred embodiments of the present invention there is provided a play item comprising a modular unit as defined herein.

In other preferred embodiments of the present invention there is provided a packaging comprising a modular unit as defined herein.

In yet other preferred embodiments of the present invention there is provided a construction system, comprising at least one modular unit as defined herein.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a perspective view of an embodiment of a modular construction unit, according to the present invention, having a flat element and an opposing co-formed surface with a plurality of parallel tubular elements attached to the flat surface thereof;

FIG. 1B is a perspective view of the modular construction unit of FIG. 1A rigidified with a rigidifying element;

FIG. 2A is a perspective view of the modular construction unit shown in FIG. 1, preformed to have a curvilinear profile across its width with a concave inner flat surface and the parallel tubular elements forming the outer surface, according to the present invention;

FIG. 2B is a perspective view of the modular construction unit of FIG. 2A with a rigidifying end element connector unit;

FIG. 2C is a perspective view of the modular construction unit of FIG. 2A rigidified with a rigidifying element;

FIG. 3A is a perspective view of the modular construction unit shown in FIG. 1A, preformed to a circular profile across its width with an inner flat surface and the parallel tubular elements forming the outer surface, to form a cylindrical unit, according to the present invention;

FIG. 3B is a perspective view of the modular construction unit shown in FIG. 1A, preformed to a circular profile across its width with an outer flat surface and the parallel tubular elements forming the inner surface, to form a cylindrical unit, according to the present invention;

FIG. 3C is a perspective view of the modular construction unit shown in FIG. 3B, rigidified and held in place with a rigidifying end element connector unit;

FIG. 3D is a perspective view of product preformed from two modular units of FIG. 1A to a “S”-like profile across its width with part of the unit having an inner concave flat surface and the parallel tubular elements forming the outer surface, and part of the unit having an outer concave surface from the parallel tubular elements and an inner flat convex surface, according to the present invention;

FIG. 4 is a perspective view of a plurality of modular construction units of FIG. 1A, assembled with some inner support tubular elements and an edge rigidifying element, according to the present invention;

FIG. 5A is a perspective view of a chair constructed from at least one modular construction unit of FIG. 1A, according to the present invention;

FIG. 5B is a perspective view of the modular construction unit used in the construction of the chair shown in FIG. 5A.

FIG. 5C is a perspective view of the modular construction unit of FIG. 1A, held by one curved end unit, according to the present invention;

FIG. 5D is a perspective view of the modular construction unit of FIG. 1A, held by two parallel curved end units, according to the present invention;

FIG. 6 is a perspective view of another chair constructed from at least two modular construction unit of FIG. 1A, according to the present invention; and

FIG. 7 is a perspective view of is a perspective view of another preferred embodiment of a modular construction unit, having a flat element an opposing coextruded surface with a plurality of parallel tubular elements attached to the flat surface thereof and a plurality of inner support tubular elements disposed in close fit association within the parallel tubular elements, according to the present invention.

In all the figures similar reference numerals identify similar parts.

### DETAILED DESCRIPTION OF EXEMPLARY EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

The following description discloses modular units 100, 200, 300, 400, made out of extrudable deformable materials such as polymers. The polymers may be selected from vinyl polymers, such as polystyrene, polyethylene, polybutadiene, polypropylene and polyvinyl chloride and polyurethanes. Also encompassed by the present invention are modular units from natural or synthetic rubbers, silicone rubber, plastic composites, or from malleable metals and metal alloys.

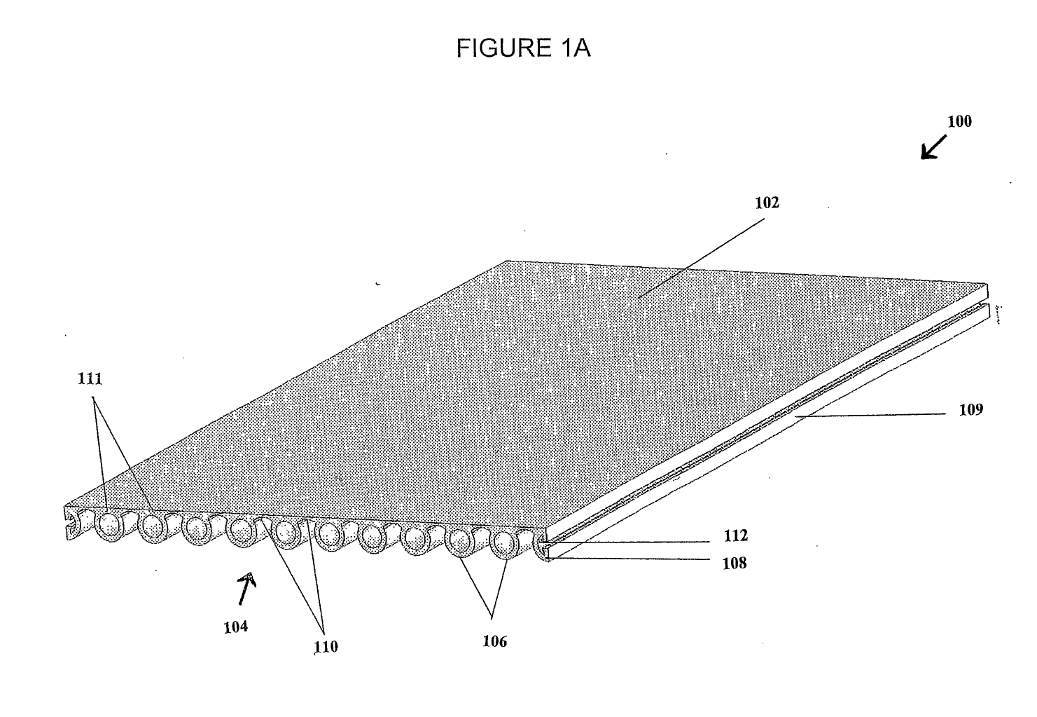

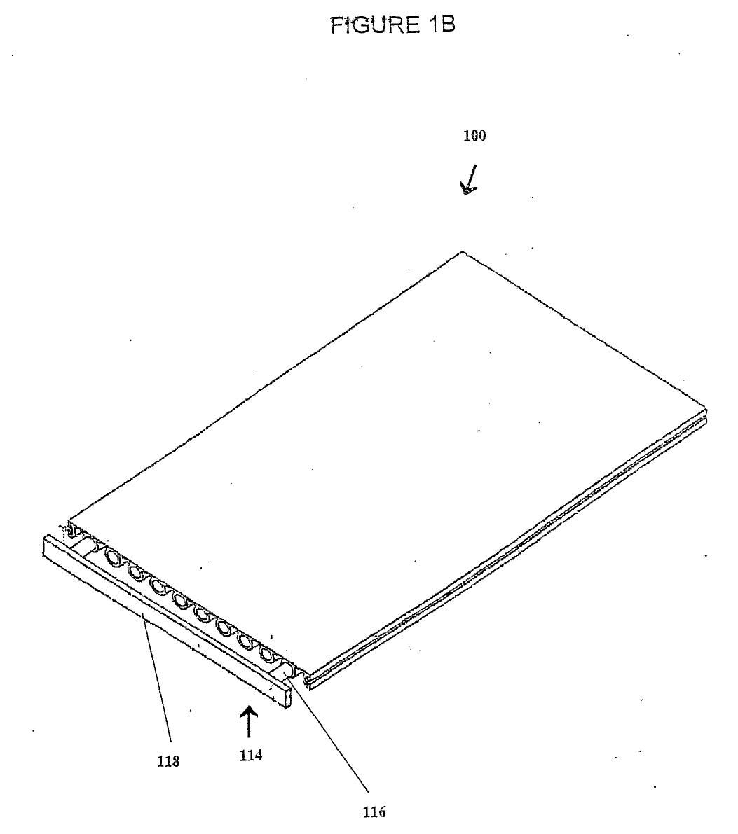

There is seen in FIG. 1A a perspective view of an embodiment of a modular construction unit 100, made of an extrudable deformable material, having a flat, sheet-like element 102 and an opposing co-formed surface 104 with a plurality of parallel tubular elements 106, each having a common wall 111 with the flat surface and which are thus attached to the flat surface. The plurality of parallel tubular elements 106 are spaced apart by spacer areas 110. In some embodiments, the spacer areas are all of similar or identical width and the parallel tubular elements are, in some embodiments substantially identical in size such that one spacer area 110 and one parallel tubular element 106 forms a repeating unit, such that the tubular elements are uniformly spaced apart. The tubular elements 106 may be have a circular cross-section or a quadrilateral cross-section and are configured to receive correspondingly formed internal support members in friction-fit association therewith.

Additionally, unit 100 comprises a pair of end elements 108, one at each longitudinal end of the sheet, each end element 108 extending the width of the sheet-like element 102, and parallel to the plurality of parallel tubular elements.

Each end element 108 comprises a slot 109 having an axis in the same plane as the axes of the hollow tubular elements 106. The slot is configured with a groove or hollow volume 112, adapted to receive in snap-fit or friction fit connection, at least one of: a connector unit, a rigidifying element and a rigidifying end element connector unit (described in more detail hereinbelow with reference to FIGS. 1B, 2B, 2C, 3C, 4 and 7).

Referring now to FIG. 1B, said figure presents a perspective view of the modular construction unit of FIG. 1A rigidified with a rigidifying element 114. Element 114 comprises at least a pair of spaced-apart projections 116 sized to be inserted into open ends of at least two spaced-apart tubular elements 106 of the same modular unit to fix the spacial relationship therebetween.

Element 114 comprises a flat end section 118, perpendicular to projections 116. In some cases projections 116 are tubular or cylindrical. In other cases, projections 116 have a quadrilateral cross-section to mate in friction-fit connection, a quadrilateral tubular element 106 (not shown). Element 114 typically fits across the width of unit 100 and projections 116 are held by elements 106, according to some embodiments relating to flat modular units, in parallel with end elements 108 (FIG. 1B).

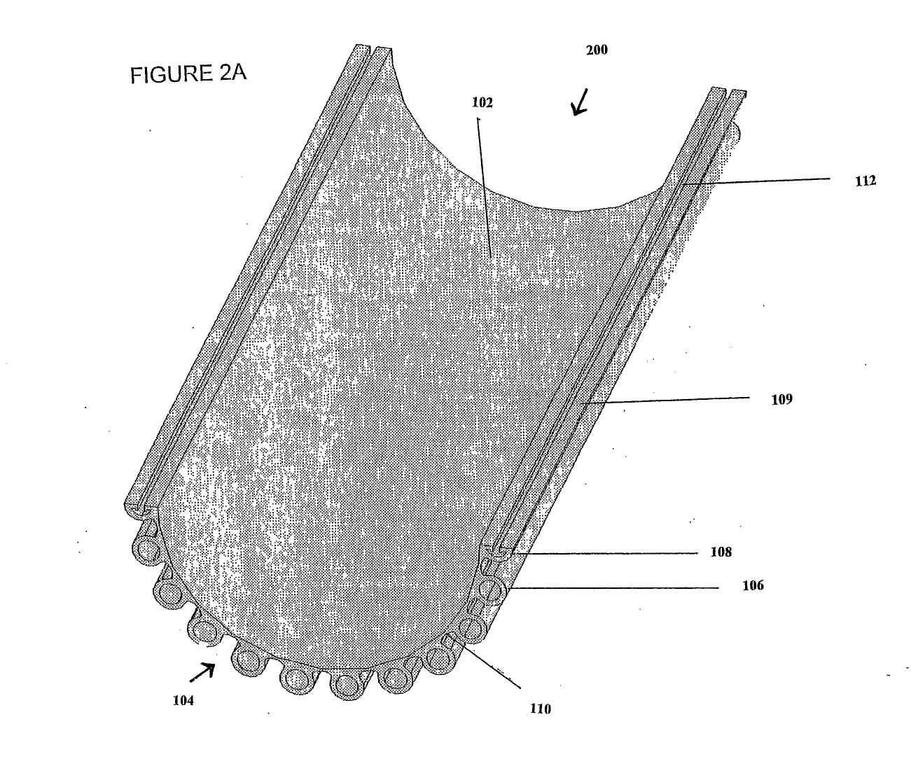

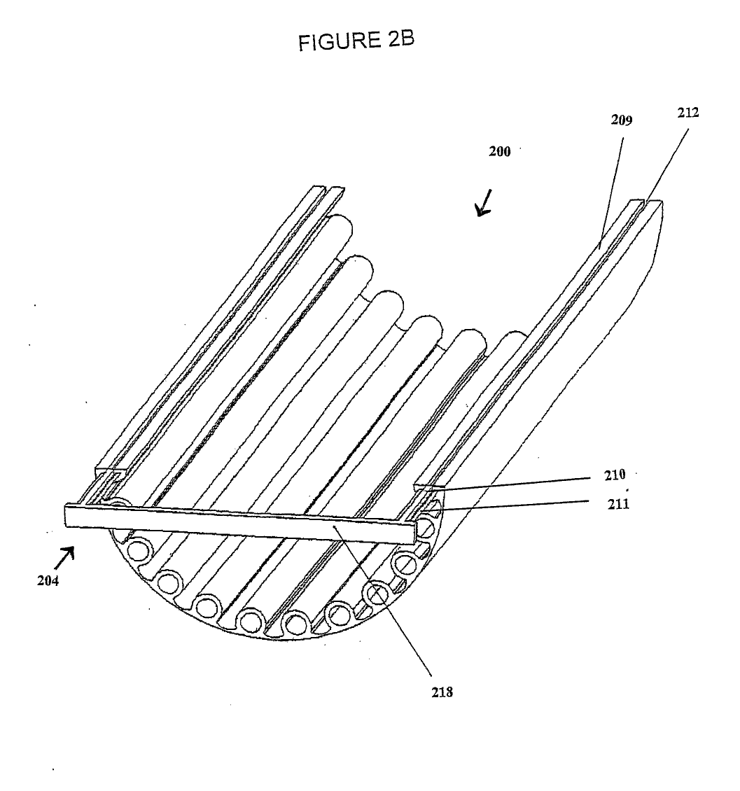

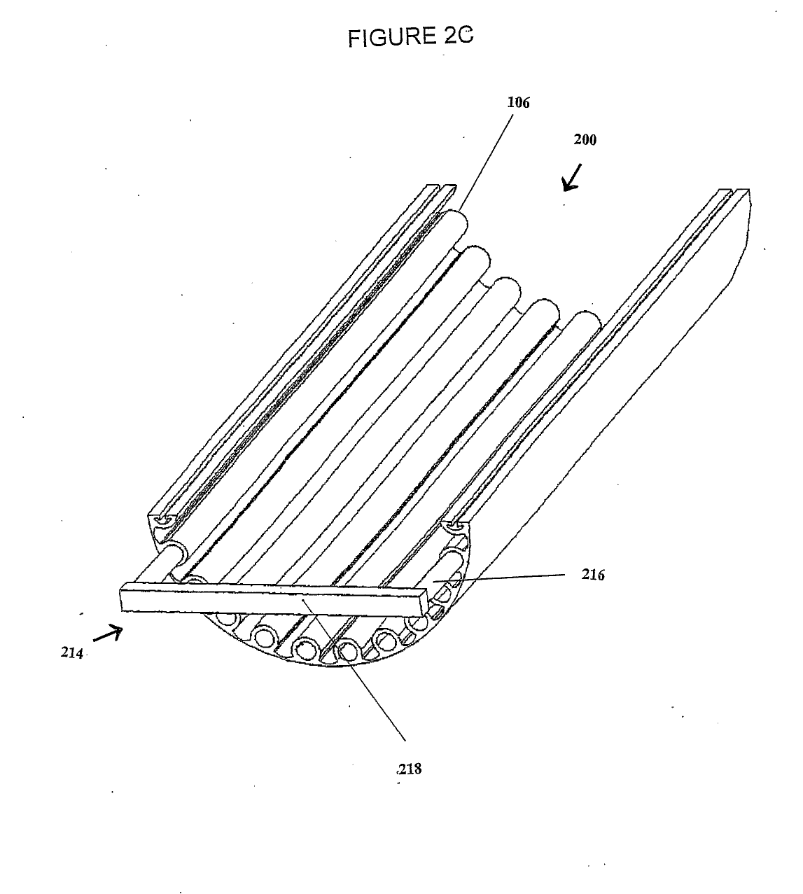

There is seen in FIG. 2A, a perspective view of a modular construction unit 200, similar or identical to unit 100 of FIG. 1, preformed to have a curvilinear profile across its width with a concave inner flat surface 102 and the parallel tubular elements 106 forming the outer surface, according to the present invention.

Referring now to FIG. 2B, there is seen a perspective view of the modular construction unit 200 of FIG. 2A with a rigidifying end element 204.

Rigidifying end element 204 comprises a flat end section 218, perpendicular to two spaced-apart projections 211. In some cases, projections 211 have an “T shaped” cross-section, adapted to be inserted into two slots 209 of end elements 208 of the same modular unit in friction-fit connection to fix the spacial relationship therebetween, as well as the curvature of the unit 200.

In some cases, when projections are fully inserted into slots 209, an end of the leg of the “T” section in the same plane as the slots 209.

There is seen in FIG. 2C a perspective view of the modular construction unit 200 of FIG. 2A rigidified with a rigidifying element 214.

Rigidifying element 214 comprises at least a pair of spaced-apart projections 216 sized to be inserted into open ends of at least two spaced-apart tubular elements 106 of the same modular unit to fix the spacial relationship therebetween. The rigidifying element also determines the curvature of unit 200.

Element 214 typically fits across the width of unit 200 and projections 216 are held by tubular elements 106, according to some embodiments. Projections 216 may be constructed to span one or several modular units 100.

There is seen in FIG. 2C is a perspective view of the modular construction unit of FIG. 2A rigidified with a rigidifying element, 214;

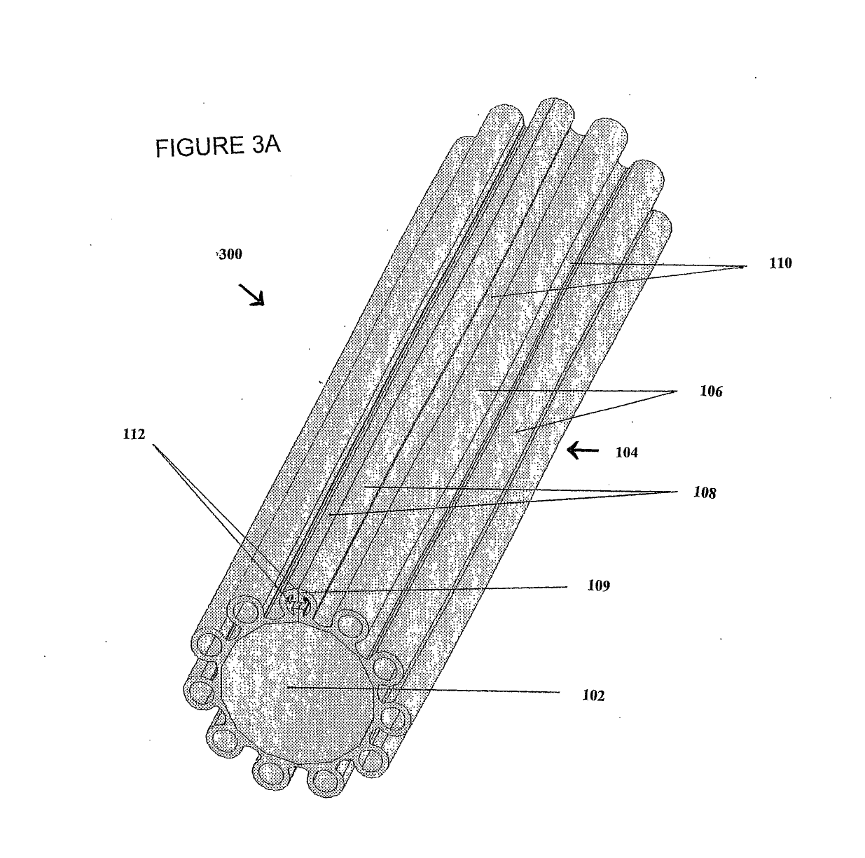

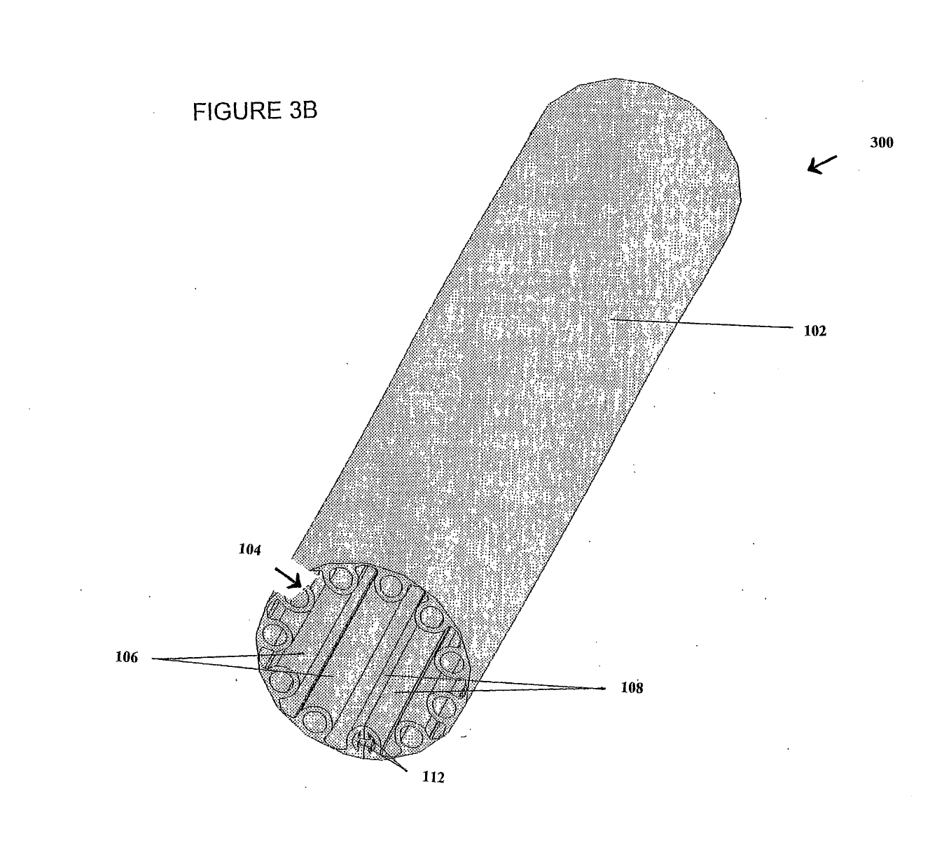

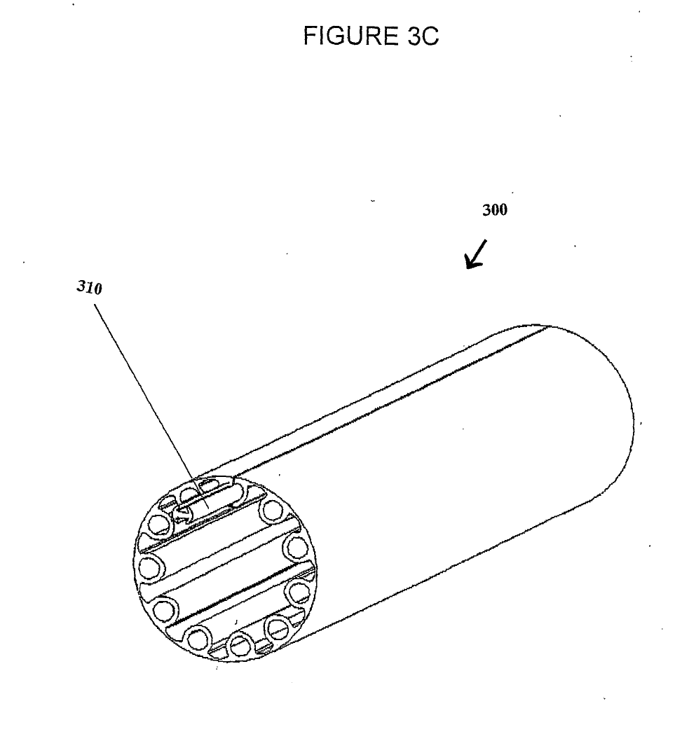

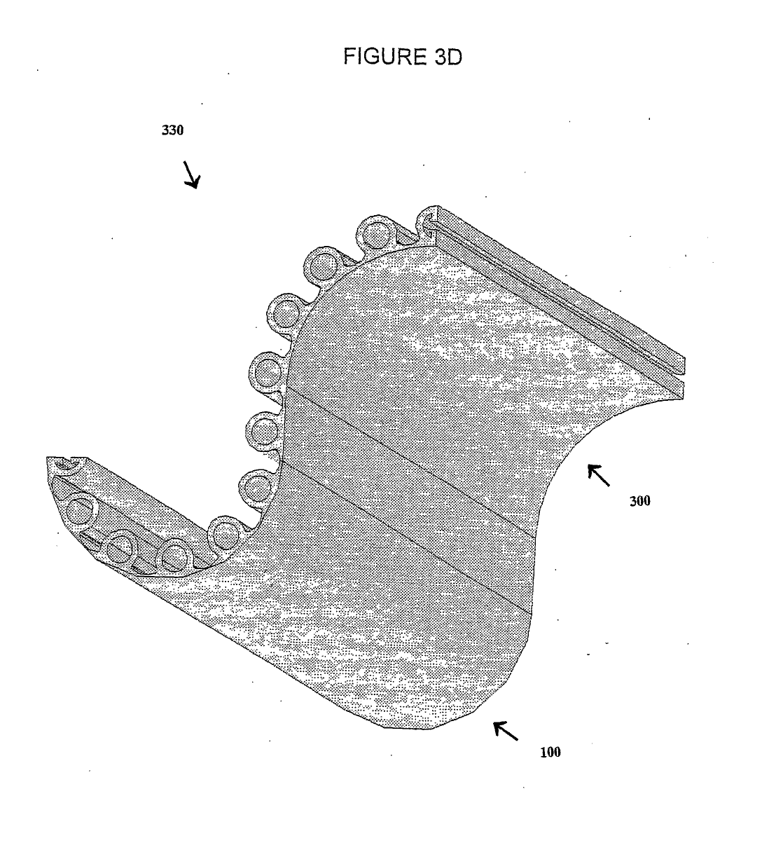

Referring now to FIG. 3A, there is seen a perspective view of a modular unit 300, similar or identical to unit 100 of FIG. 1A, preformed to a circular profile across its width with an inner flat surface 102 and the tubular elements 106 forming the outer surface, to form the cylindrical unit, according to the present invention.

It is seen from FIG. 3A that two spaced apart slots 109 of end elements 108 are, in this embodiment, brought into contact, thus forming an “H-shaped” cross-section groove 112 together.

There is seen in FIG. 3B a perspective view of a modular unit 300, similar or identical to unit 100 of FIG. 1A. In this embodiment, unit 300 is preformed to have circular profile across its width with an outer flat surface 102 and the tubular elements 106 forming the inner surface, to form a cylindrical unit.

Referring now to FIG. 3C, there is seen a perspective view of the modular unit 300 shown in FIG. 3B, rigidified and held in place with a rigidifying end element connector unit 310. Connector 310 is configured to be inserted into two slots 108 forming the “H-shaped” groove 112 of the same modular unit to fix the spacial relationship therebetween. In some cases, the unit may fixed into a cylindrical shape. In some other embodiments, the cross-section may be rectangular, triangular or any other required shape. However, in order to form various shapes, a combination of one or more rigidifying elements and end units may be required to form the shape.

For example FIG. 3D is a perspective view of a product 330, preformed from two modular units, such as 100 of FIGS. 1A and 300 of FIG. 3A to form an “S”-like unit 330. Unit 330 requires, for example two rigidifying units (not shown) to hold it in place, one across unit 100, and one across unit 300. Unit 330 is formed from at least two sub-units, a unit 300 having an inner concave flat surface and the parallel tubular elements forming the outer surface, and a unit 100 having an outer concave surface from the parallel tubular elements and an inner flat convex surface.

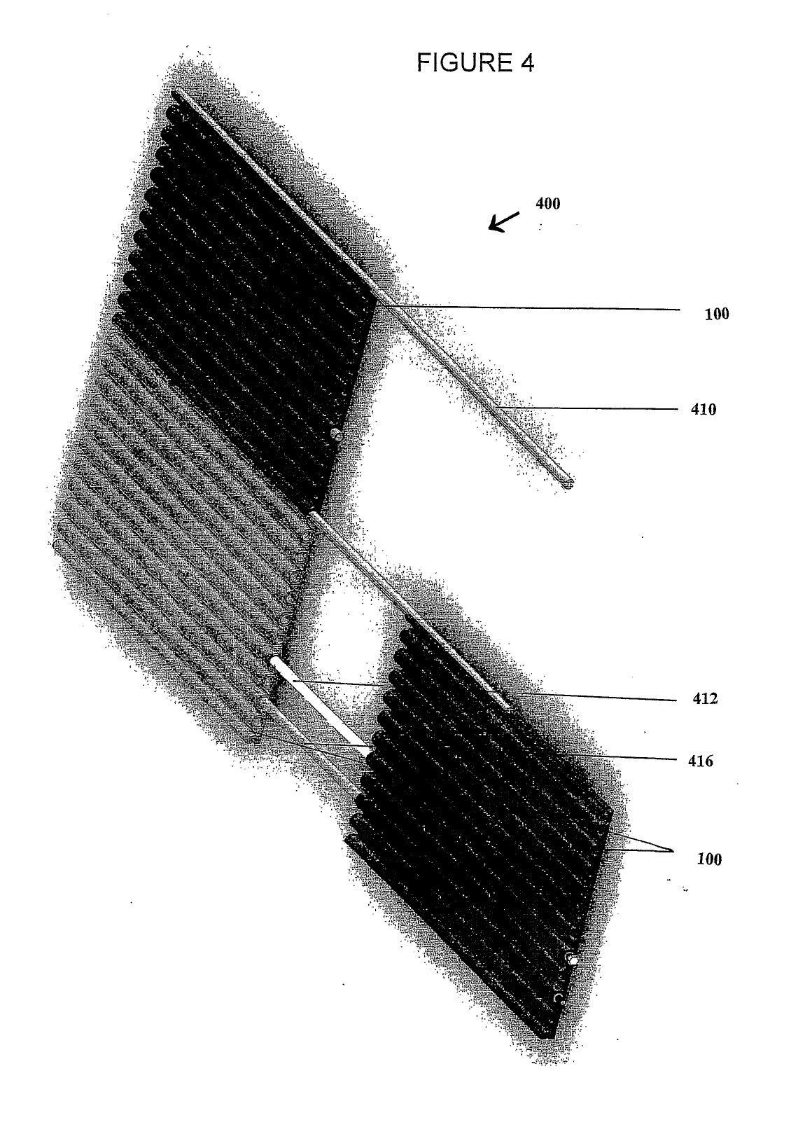

Turning now to FIG. 4, there is seen a perspective view of a plurality of modular construction units 100 of FIG. 1A, assembled with some inner support/rigidifying elements 412, 416 and edge rigidifying element connector units 410 to form a planar unit 400.

Edge rigidifying element connector units 410 may be constructed to span one or several modular units 100.

Element 416 is hollow, whereas element 412 is solid. Element 412 may have a circular cross-section, a quadrilateral cross-section or any other shape designed to mate tubular element 106. These elements may be constructed to span one or several modular units 100.

Element 416 may have a circular cross-section, a quadrilateral cross-section or any other shape designed to mate tubular element 106.

Construction units of the invention may have any convenient number of contiguous modular units 100, as well as any number of spaced-apart units 100 in combination with any number of end units 114 (not shown), rigidifying elements, 412, 416, and edge rigidifying element connector units 410. It should be understood that elements, 412, 416 and connector units 410 are, according to some embodiments, parallel one to the other and to the length of planar unit 400. Elements, 412, 416 and connector units 410 are, and are typically perpendicular to a flat end section 118 of end unit 114, and parallel to projections 116.

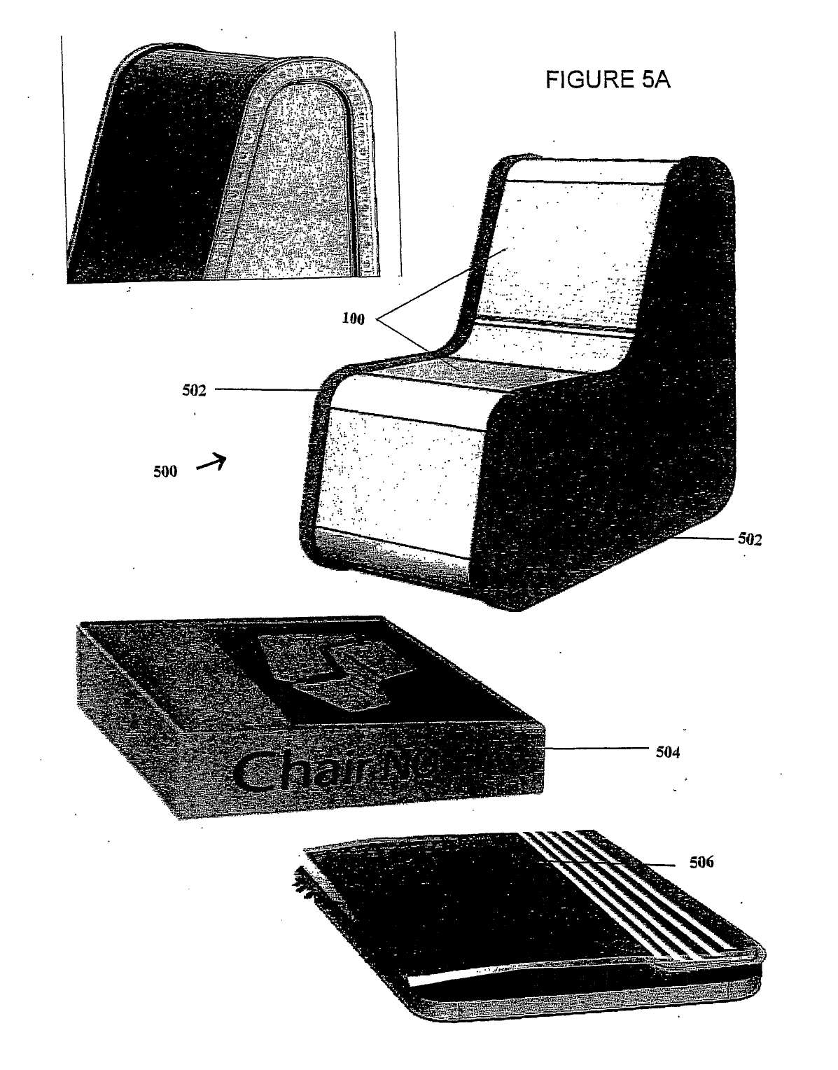

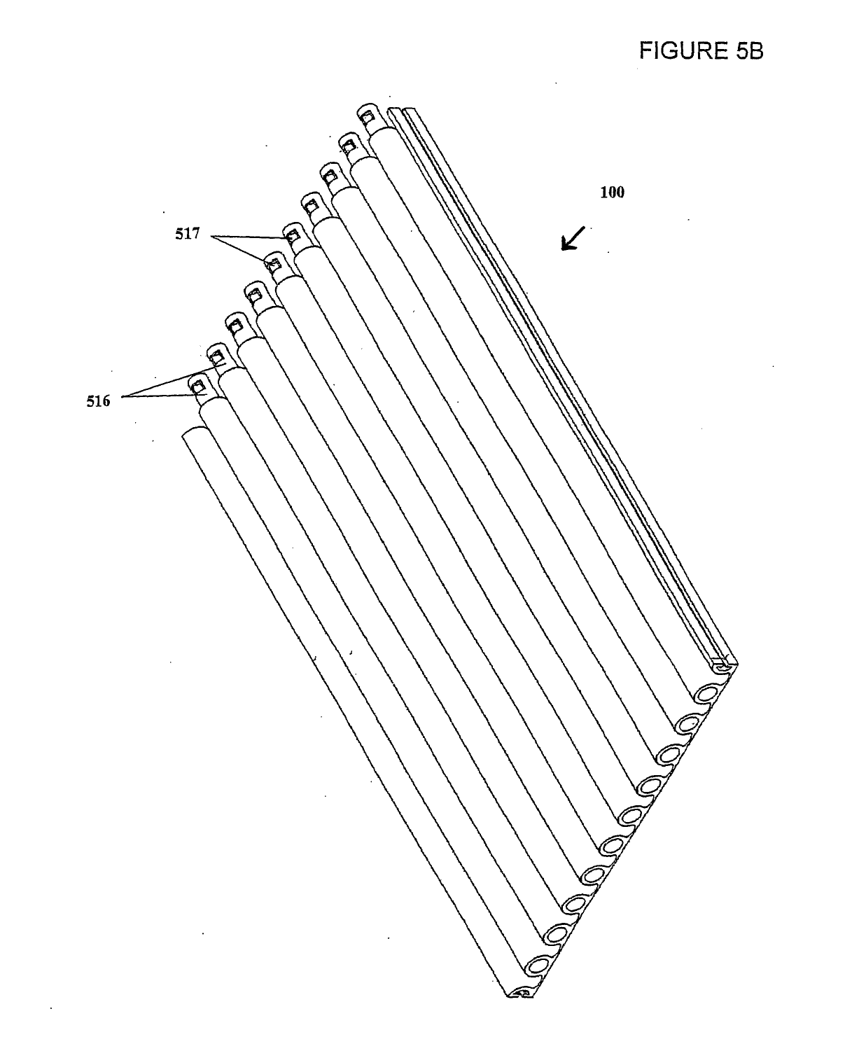

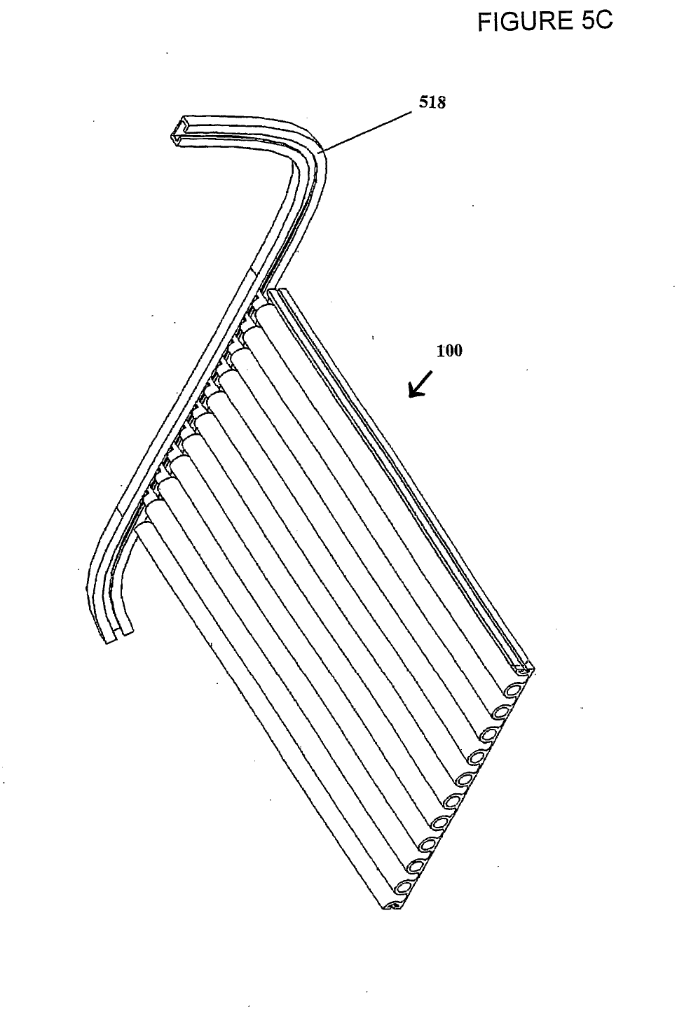

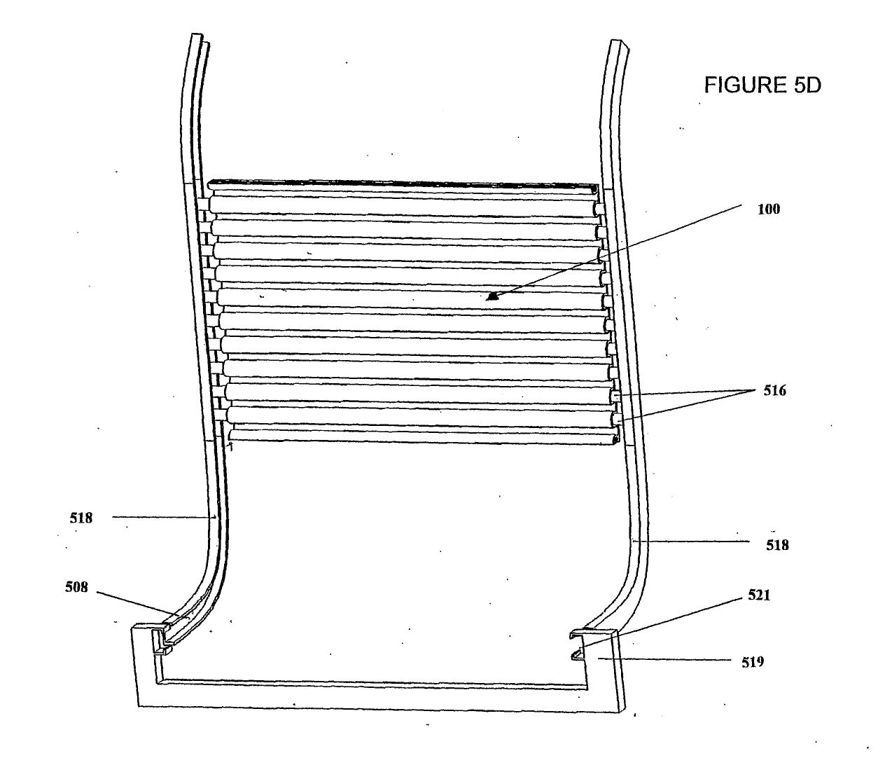

Referring now to FIG. 5A, there is seen a perspective view of a chair 500 constructed from at least one modular construction unit 100 of FIG. 1A, according to the present invention. Chair 500 comprises end units 502 and packaging carton 504 and additional structural elements 506. Rigidifying element 514 comprises at least a pair of spaced-apart projections 516 sized to be inserted into open ends of at least two spaced-apart tubular elements 106 of the same modular unit 100 to fix the spacial relationship therebetween. Chair 500 is constructed to be assembled from a flat-pack in carton 504, and normally is provided with instructions (not shown) for how to assemble the chair, as well as one or more of: rigidifying elements, 412, 416, and edge rigidifying element connector units 410, and end units 114 (not shown).

FIG. 5B is a perspective view of the modular construction unit 100 of FIG. 1A, provided with a plurality of internal support members 516 projecting therefrom and having notched ends 517 adapted to be slidingly inserted into an open end 508 of slotted rail 518 as seen in FIG. 5C, and to be positioned at a predetermined section along said rail 518.

Referring now to FIG. 5D there is seen the unit 100 of FIG. 5B wherein said unit is provided with a plurality of internal support members 516 projecting from both ends thereof and wherein the notched ends 517 of said support members 516 are inserted and held by notched ends 517 between two spaced-apart slotted rail elements 518. Also seen in FIG. 5D are frame elements 519 provided with end protrusions 521 sized to be inserted into open ends 508 of the slotted rails 518 in order to rigidify the chair structure.

Alternatively, the internal support members 516 may be an integral part of unit 100.

The rail may be formed in a variety of shapes such as having adjacent straight and curved sections, the curved sections formed to form bends around one or more axes. Additionally, rails 508 may constructed from various materials such as plastics or metals. One or more rails may form the shape of an edge of a construction. For example, in a chair, the rails may form the outer edge of the chair, and the modular units, may be the back support and seat.

It can be seen from FIG. 5D, that the modular construction unit of FIG. 1A, is held by the two parallel rails 508, according to the present invention. Upon construction of a chair, for example, modular unit 100 with projecting internal support members 516 slideably engage into rails 508. This process may be repeated for several modular units 100, each unit being slid until it is adjacent to one or more modular units to form one or more surfaces of the chair.

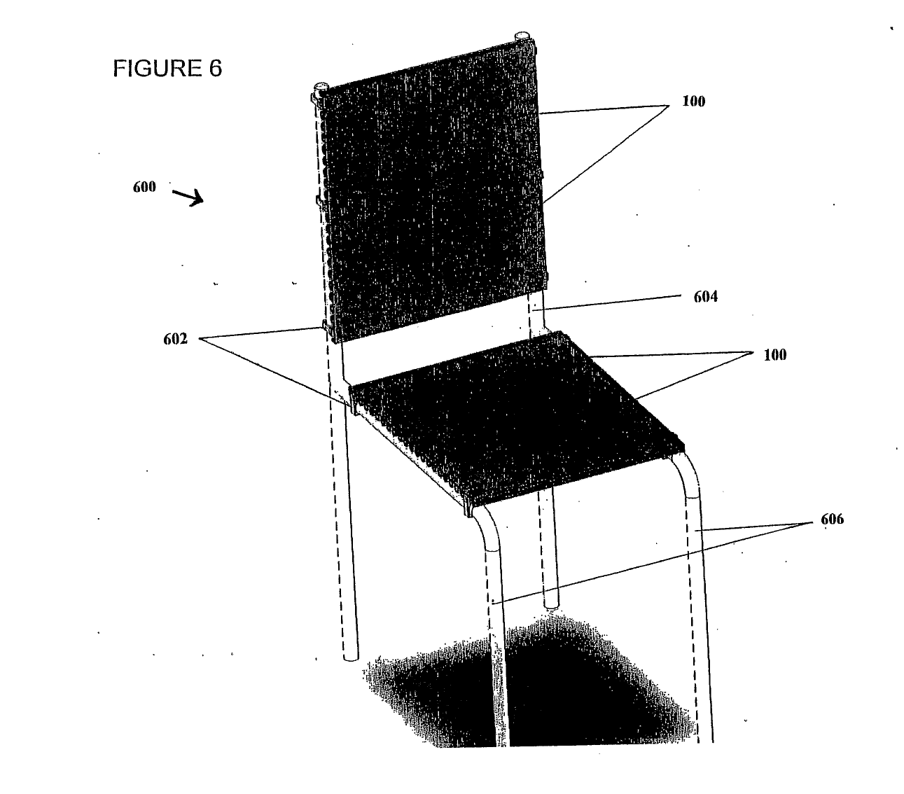

There is seen in FIG. 6, a perspective view of another chair 600 constructed from at least two modular construction units 100 of FIG. 1A, according to the present invention. Chair 600 comprises a frame, 604, and at least two legs 606, which are brought into close-fit arrangement with the frame, by methods known in the art. Chair 600 is assembled by affixing the legs to the frame and bringing the modular units into rigid connectivity by means of clips 602. Clips 602 may be brought into snap-fit connectivity with the frame of the chair, though other mechanisms for fixing the units 100 to the frame, known in the art, are within the scope of this invention.

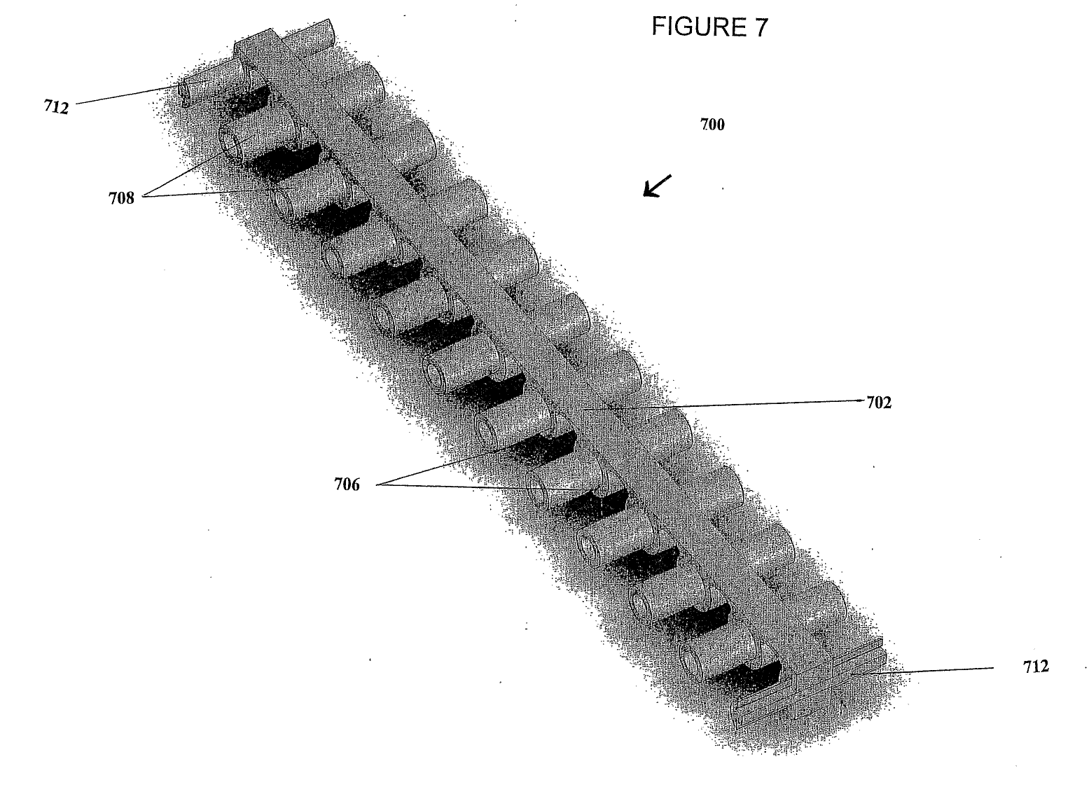

Turning now to FIG. 7, there is seen a perspective view of another preferred embodiment of a modular construction unit 700, similar conceptually to unit 100 of FIG. 1, having a flat element 702 and an opposing coextruded surface with a plurality of parallel tubular elements 706 attached to the flat surface thereof and a plurality of inner support tubular elements 708 disposed in close fit association within the parallel tubular elements, according to the present invention. This type of unit may be used for, inter alia, electrical, plumbing and constructional structures.

Since construction units generally have a uniform cross-section, they can be manufactured using the most efficient manufacturing method, such as by extrusion. Construction units for different embodiments, no matter how diverse, may be manufactured utilizing the same extrusion dies. Dies would require relatively minor adjustments between manufacturing runs to adapt them to meet different specification values, such as changes in wall thickness.

Holes may be molded, punched, or drilled into any flat surface of the construction units during manufacturing (not shown) to provide sites for fastening with conventional fasteners, such as screws or bolts—or to keep unit weight to a minimum.

Rigidifying elements, 412, 416, edge rigidifying element connector units 410 and end unit 114 are typically constructed of a material more rigid than the material of the unit itself. In some cases, the material of construction is selected from a polymer as above, a reinforced polymer, a composite, a metal or metal alloy.

Various processes known in the art may be used to form the modular units 100, 200, 300, 400, including, but not limited to, injection molding, extrusion, blow molding, thermoforming, rotational molding and compression and transfer molding.

In some cases, the unit may be formed from a block of the extrudable deformable material and the hollow elements may be formed by drilling and removing excess material.

Some products formed from one or more modular units include, but are not limited to, boxes and storage containers, closets, drawers, furniture, armchairs and chairs, tables, commodes, shelves, hammocks, swings, playground equipment, mats, shoes and clogs, bags, suitcases and travel cases, buggies and prams, storage units, shock absorbing items, sound absorbing items, car parts and car seats, blood-circulatory equipment, sheds, storehouses, wheeled items, such as trolleys, moveable items, wall units, roof units, tiles, bathroom equipment and furniture, conveyor belts and industrial items.

Other envisaged applications of the modular units of the current invention pertaining to nondestructive universal adaptability and re-use include convention exhibits, theatrical and window displays, office and home partitions, knock-down furniture and animal shelters.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A modular unit used for constructing various items, said unit being made of a deformable material and characterized in that said unit has a flat element which is co-formed with a plurality of parallel tubular elements attached to a surface thereof, wherein said tubular elements are spaced apart from each other and each tubular element has a common wall with said flat element, said flat element having an inner flat surface and an outer surface and each of said tubular elements having a peripheral outer surface and an inner surface and wherein a longitudinally extending segment of said peripheral outer surface of each of said tubular elements is co-formed with a longitudinally extending segment of an outer surface of said flat element to form said common walls of said flat element and said tubular elements.

2. A modular unit according to claim 1, further comprising a pair of slotted end elements, one at each longitudinal end of the sheet, each slotted end element extending the width of the sheet, and parallel to the plurality of parallel tubular elements.

3. A modular unit according to claim 2, wherein each slotted end element comprises a slot extending along an axis in the same plane as the axes of the hollow elements, said slot configured to receive at least one of a connector unit, a rigidifying element and a rigidifying end element connector unit.

4. A modular unit according to claim 1, wherein the plurality of tubular elements are uniformly spaced apart.

5. A modular unit according to claim 1, wherein the plurality of tubular elements are substantially identical.

6. A modular unit according to claim 1, wherein at least one of the tubular elements is adapted to receive an internal support member.

7. A modular unit according to claim 6, wherein the internal support member is solid.

8. A modular unit according to claim 7, wherein the solid internal support member is selected from a member having a circular cross-section and a quadrilateral cross-section.

9. A modular unit according to claim 6, wherein the internal support member is hollow.

10. A modular unit according to claim 9, wherein the hollow internal support member is selected from a member having an open circular cross-section and an open quadrilateral cross-section.

11. A modular unit according to claim 1, wherein the extrudable deformable material is selected from: polymers including polystyrene, polyethylene, polybutadiene, polypropylene and polyvinyl chloride and polyurethanes; natural or synthetic rubbers; and plastic composites.

12. A modular unit according to claim 1 in combination with a rigidifying element, said element being provided with at least a pair of spaced-apart projections sized to be inserted into open ends of at least two spaced-apart tubular elements of the same modular unit to fix the spacial relationship therebetween.

13. A modular unit according to claim 1 in combination with a rigidifying end element connector unit, said unit being provided with at least a pair of spaced-apart projections sized to be inserted into open ends of at least two spaced-apart tubular elements of the same modular unit to fix the spacial relationship therebetween.

14. A modular unit according to claim 2 in combination with at least one connector unit, said connector unit being sized to be inserted into two slots selected from two slots of the same modular unit to fix the spacial relationship therebetween and one slot on each of two modular units to connect the two modular units together.

15. A construction system comprising:
a. at least one modular unit according to claim 1, and
b. at least one of: a connector unit, a rigidifying element and a rigidifying end element connector unit, and at least one internal support member.

16. A construction system according to claim 15, further comprising at least one rail adapted to receive one or more of: the connector unit, the rigidifying element, the rigidifying end element connector unit and at least one internal support member.

17. A construction system comprising at least one modular unit according to claim 1, in combination with a pair of rails adapted to be spaced apart and to retain said modular unit to form a segment of a completed furniture unit.

18. A method for forming a modular unit according to claim 1, comprising forming an extrudable deformable material into a flat element and into a plurality of parallel tubular elements attached to a surface thereof, wherein said tubular elements are spaced apart from each other and each tubular element has a common wall with said flat element.

19. A method according to claim 17, wherein the forming step is a process selected from extruding and molding.

20. A method according to claim 17, further comprising: cutting sections of the modular unit to form modular unit sections.

21. A method according to claim 17, wherein the extrudable deformable material is selected from polymers may be selected from vinyl polymers, such as polystyrene, polyethylene, polybutadiene, polypropylene and polyvinyl chloride and polyurethanes, natural or synthetic rubbers, silicone rubber, and plastic composites.

22. A furniture element comprising a modular unit according to claim 1.

23. A play item comprising a modular unit according to claim 1.

24. A packaging comprising a modular unit according to claim 1.

25. A construction system, comprising at least one modular unit according to claim 1.
